(19) United States
(12) Patent Application Publication
(10) Pub. No.: US 2010/0242099 A1
(43) Pub. Date: Sep. 23, 2010

(54) Method and apparatus of UI design for web-based computer user working environment

(76) Inventor: Sheng Tai (Ted) Tsao, San Jose, CA (US)

Correspondence Address: Sheng Tai (Ted) Tsao, 2979 Heidi Drive, San Jose, CA, 95132, US

(21) Appl. No.: 12/487,976

(22) Filed: Jun. 19, 2009

Related U.S. Application Data
(63) Continuation-in-part of application No. 11/374,302, filed on Jul. 2, 2004.
Application No. 11/374,302 is a continuation-in-part of application No. 10/116,511, filed on Apr. 5, 2002, now Pat. No. 7,734,778.

(51) Int. Cl. H04L 9/32; G06F 21/00; G06F 15/16

(52) U.S. Cl. 726/5; 726/3; 709/229

(57) ABSTRACT

This invention takes the course of evolution and creating a web based computer user work environment for a control management station and its associated systems on the network crossing Intranet, Internet or LAN. Therefore, users can access and manage the control management station and all its associated system through web browser on any other systems or devices. To establish a web based computer user work environment, the resources information on control management station and on associated systems on network need to be collected and convert them to standard structured format for web based communication and further displaying them in web browser. These information need to be collected by control management station at its and the associated systems' boot up time or at the time when a user logins and requests to access and manage these resources.

### PRIORITY

This application is the continuation-in-part of the U.S. patent application Ser. No. 11/374,302, filed in the name of the same inventor and entitled “Display, View and Operate Multi-layered Item List in Web Browser With Supporting of Concurrent Multi-Users”, and it is also the continuation-in-part of U.S. patent application Ser. No. 10/116,511, filed in the name of the same inventor and entitled “Intelligent Distributed Virtual Server”.

### FIELD OF THE INVENTION

This invention relates to the methods and apparatus for a new user interface design by creating web-based multi-layered items list used to manage and manipulate information and system resources in a web-based computer user work environment.

### BACKGROUND OF INVENTION

The computer user work environment has evolved from paper tape or punch cards of early years to command line user work environment on a native system in the 1970's, and to native window object select and click based user work environment in the middle of the 1980's.

Network-based user work environments have existed since the 1980's and 1990's such as Microsoft's terminal service, the Telnet of Unix & Linux system etc. These types of software let users to access and operate the target system from another system remotely. There are some network management software tools, which primarily focus on monitoring the targeted systems' network activities. In addition, all of the software mentioned has limited mobility and capability because they are required to install specialized software on the remote system in order to be accessed. Therefore, these software tools are not easy to be ported and further limit the user's ability to remotely work from various kinds of systems or devices.

There are web-based application software tools that allow users from a web browser of a remote system to access web applications on a web server or device. However, these software tools are not designed for creating a web based computer user work environment. There is web-based software tool that allows people to manage a system remotely. However, they also do not create a web-based computer user work environment, instead, it dumps the existing computer user work environment of a particular system to a web browser on a remote system. This type of system has many limitations. For example, during a web presentation the web browser can not display content of a file that exceeds 10 MB in size.

A new web-based computer user work environment (WCUWE) has been introduced in parent patent applications entitled “Concurrent Web Based Multi-Task Support for Control Management System”, and entitled “IP Based Distributed Virtual SAN” in the name of same inventor. The present invention will focus on creating a user interface (UI) of the WCUWE by utilizing multi-layered item list (MLIL) for providing a much flexible web-based user working environment of the CCDSVM. The WCUWE provides users to access and operate the systems of the CCDSVM from any conventional web browser of any system or electronic device. Due to the capability of expanding the CCDSVM across the LAN, Intranet and Internet and its strong security, the WCUWE actually provides an alternative solution for a more mobilized and flexible computational environment than traditional native window or command line based user work environment.

### BRIEF SUMMARY OF THE INVENTION

The prior application, entitled “Concurrent Web Based Multi-Task Support for Control Management System”, has described the creation and the benefits of the new web-based computer user work environment (WCUWE) with multi-tasking support. The prior application, entitled “IP Based Distributed Virtual SAN” has actually described a mechanism of automatically and dynamically provisioning and grouping one or more system units of the CCDSVM to form one or more service pools in a cross-domain environment. In one embodiment, the CCDSVM includes and controls a file service pool and a storage pool, where the system unit of file system pool can utilize storage volumes provided by the storage pool. With the WCUWE, one or more service pools/groups of CCDSVM can be accessed and managed from a web-browser anywhere on the net. In addition, it permits multiple users, each from their own single web browser on a system or device anywhere over the network to perform one or more concurrent tasks of accessing and managing the CCDSVM.

The mentioned tasks can be run in the WCUWE environment of the CCDSVM include interactively selecting one system in CCDSVM at a time to perform task of storage configuration, storage volume allocation and assignment, storage partitioning and repartitioning for RAID or SCSI or IDE disk drives, make and mount file system on the top of storage volume; select any system in CCDSVM for monitoring status of its storage, network, CPU, memory, processes/threads and other resources; move or transmit data such as a multiple gigabytes of file or other form of data form from any point or any system to another point or system within said pools; setup authentication of specific user from a specific web browser with certain privilege for entire CCDSVM or for a specific system, which could be any storage server or host or control station; setting up the authentication for specific services on one or more specific hosts, or on control system, and stores the authentication information in a list on control system; create file system, file and file-folder or directory structures, and perform tasks of accessing and managing file located either on the controls station, system units or hosts including accessing application and/or data services; and the mentioned tasks and operations are normally can be run in command line or native window based user interactive work environment.

Since the emergence of the native window & user interactively click based computer user work environment (CUWE) in the middle of 1980's, users are able to display, view and operate resources information of a computer system or devices by mouse-click through corresponding multi-layered item list. For example, the files & folders list or email message folders or devices folders and other resources on MS Window system all can be conveniently accessed and managed via the multi-layered item list. In other words, supporting multi-layered item list has become an important part of native window object selecting and clicking based computer user work environment. However, with new WCUWE for the CCDSVM, let one or multiple concurrent users to effectively and simultaneously display, view & operate item list in a single web-browser for corresponding resource such as for deeply nested files & folders, or for multi-group provisioned systems or devices has became an increasingly unprecedented challenge. The mentioned prior applications together with the present invention have successfully solved such challenge in creating a web-based UI of WCUWE of CCDSVM with the deployment of multi-layered item list (MLIL), which also can be called as folder-tree.

These and other features, aspects and advantages of the present invention will become understood with reference to the following description, appended claims and accompanying figures.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating one embodiment of a CCDSVM layout with a central control management system and one or multiple provisioned system units, client systems and console systems.

FIG. 2 a) is a block diagram illustrating one embodiment of a variation of a CCDSVM layout only having a standalone central control management system without any provisioned system unit, and can be accessed by client systems and console systems.

FIG. 2 b) is a block diagram illustrating one embodiment of a variation of a CCDSVM layout with a central control management system provisioned system units (which also has a native web-browser), provisioned client systems (which is are identical to system units), and console systems.

FIG. 2 c) is a block diagram illustrating one embodiment of a variation of a CCDSVM layout with a central control management system provisioned system units, provisioned client systems (which does not have a web-browser and is for non-web accessing), and console systems.

FIG. 3 is a block diagram illustrating the various pieces of CCDSVM software modules residing on central control management system, on provisioned system units, on client systems, and on console systems in accordance with one embodiment of the present invention.

FIG. 4a) is a simplified diagram illustrating one embodiment of a Multi-Layered Item List (MLIL) of a CCDSVM, where each node on the (MLIL) at a different layer may represent an associated system resource.

FIG. 4b) is a simplified diagram illustrating one embodiment of a Multi-Layered Item List (MLIL) of a CCDSVM, which consists a single node on the (MLIL).

FIG. 5a) is a simplified diagram illustrating one embodiment of a web-based pop-up menu associated with a disk drive node on a MLIL with two nodes for disk operation on the control system.

FIG. 5b) is a simplified diagram illustrating one embodiment of a web-based drop-down operation menu that can be used for selecting a system within said CCDSVM for further accessing.

FIG. 6a) is a simplified diagram illustrating one embodiment of a web-based pop-up operation menu designed for managing a storage node of an MLIL.

FIG. 6b) is a simplified diagram illustrating one embodiment of a web-based pop-up operation menu, which is associated with each of a six nodes in a MLIL for file and file folder management, where each node is also bound and represented by a graphic image of file or file folder. Therefore, when a user clicks on the file or file folder image of each node, the pop-up operation menu will pop up on the user's web browser and further allow the user to select a suitable operation option for performing system operations or tasks.

FIG. 6c) is a simplified diagram illustrating one embodiment of a web-based pop-up operation menu associated with a MLIL with three nodes and two levels of for management of control system and provisioned system units, where each node is bound with said pop-up operation menu and represented by a graphic system image. Said operations could include, but not be limited to Shutdown system, Reboot system, System status for inquiry of the system status of CPU, memory, storage, network, etc., and Change Usage for changing server's usage from one purpose to another purpose, and so forth without limitations.

FIG. 7 is a simplified diagram illustrating one embodiment of a web-based display of provisioned system units, which were automatically & dynamically grouped by group ID and associated & represented by a MLIL with two levels and seven nodes.

FIG. 8 a) is a simplified diagram illustrating one embodiment of a web-based sub-folder display of system groups, provisioned system units and their associated storage devices under a system group, which are associated and represented by a MLIL with three levels and six nodes.

FIG. 8 b) is a diagram illustrating one embodiment of a web-based folder-tree used for displaying of system groups, provisioned system units and files & folders under a system group and system unit, which are associated and represented by a MLIL with three levels and 15 nodes, where each node is bound to an appropriate pop-up operation menu and graphic image representing said node.

In all embodiments of the exampled MLIL, said operation menus, and graphic images are encoded into web page for display in web browser with any suitable or combination of suitable programming languages such as C, C++, Java, Javascript, HTML, XML, WML and so forth without any limitations.

FIG. 9 illustrates one example of how does the file system on system unit 3 in a group can be accessed. A user can interactively click a system group node on the top level MLIL folder tree to display one or more systems under the system group; then selects and clicks a specific system node to display one or more file systems on the specific system; After one or more file systems on a system are displayed, the user can select and click on a specific file system node to display one or more file folders and files under the file system; The user can continue to select and click on the next level of file folder node to access one or more next level file-folders and files as long as there is next level physical resources of the files or folders. Meanwhile, the user can select any specific file or file folder and then right click on the selected object to bring up the pop-up operation menu to further select a designated operation for performing a designated task, wherein in one embodiment, each file folder node bound with file folder operation menu, while file node bound with file operation menu.

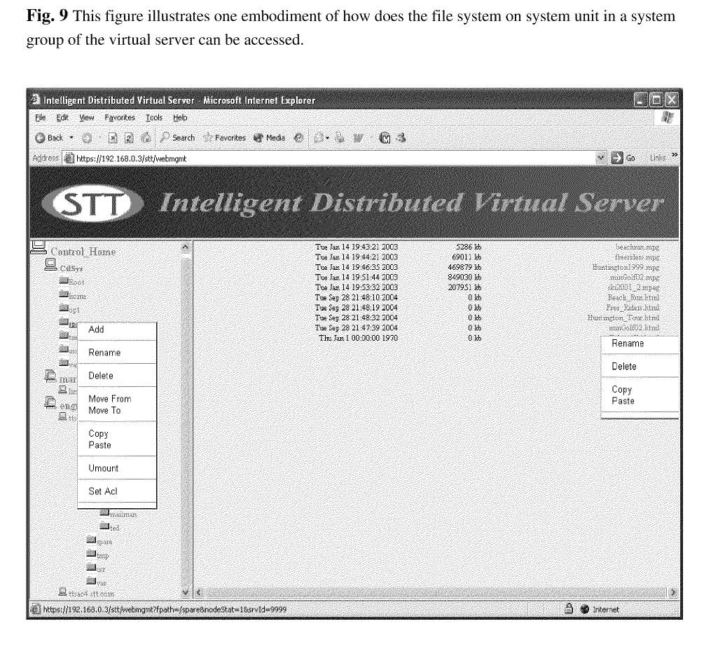

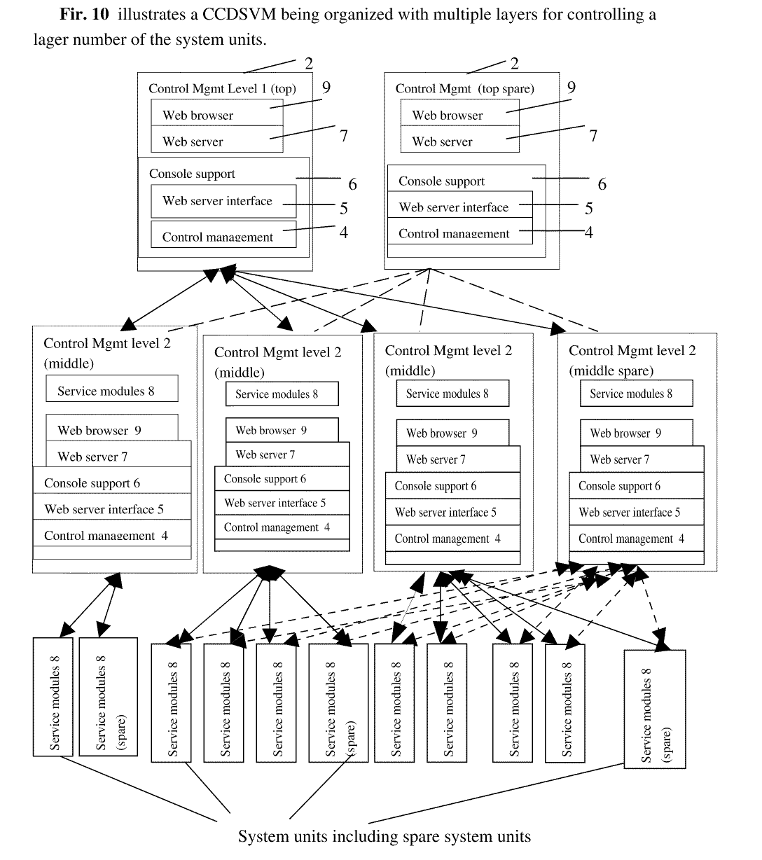

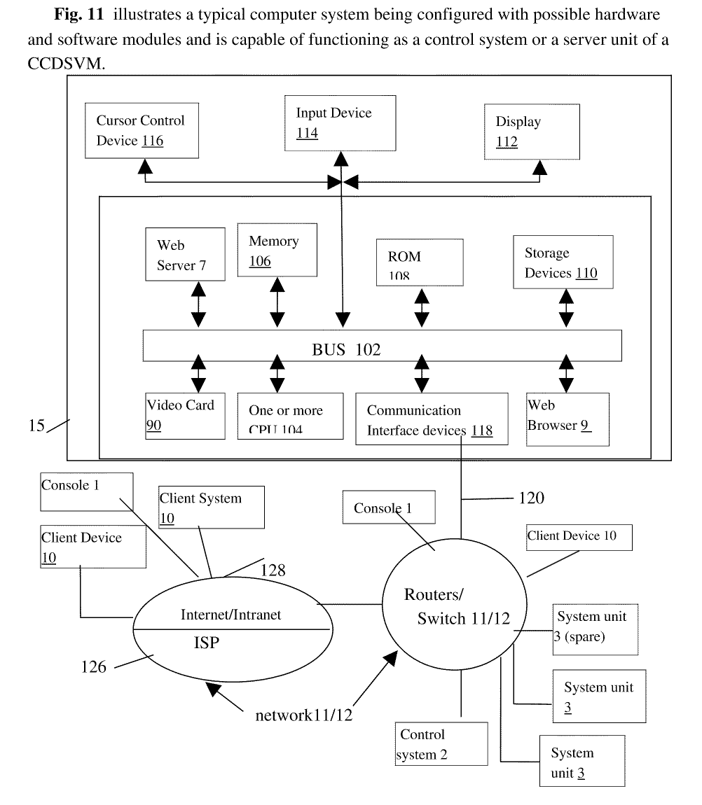

The illustration of FIG. 9 has displayed one control system and two system groups that are name marketing and engineering group. Each system group has one or more system units. Each system group can display its one or more file systems, one or more file-folders/directories, and one or more files under each file-folder/directory. Also, a pop-up operation menu for file-folder/directory can be bring up when user right click on any file-folder/directory. The operating option includes “Add” new file-folder/directory, “Rename” or “Delete” existing file-folder, “Move From/Move to” or “Copy/Paste” for existing file folder, “Umount” to un-mount a file system from a file-folder, and “Set ACL” to set accessing permission on file-folder to be accessed by one or more users. In one embodiment, the files under a file folder on a system unit in the group engineering are displayed. Each file also displayed with attributes of name, size, and time stamp. Also, an operation menu for file can be bring up upon user right clicks on the file name, and an operating option can be selected, and further the task can be submitted.

FIG. 10 illustrates one embodiment of a layered CCDSVM structure. There are 3 layers in the figure, 10. Nevertheless, a CCDSVM with more layers are also possible and it shall work the same way as 3 layers of CCDSVM without limitation. With this layered structure, the CCDSVM can be sub-divided into different groups and each group is controlled and managed by a middle layer (level 2 control system in this case) system unit. For example, each level-2 control node (middle level system unit) could function both as a Control system for the System Units below it in a group and as a System Units for level-1 Control system (top control node). Therefore, the level-2 node must have related software modules for both the Control system and System Units. Also top control system keeps a list of next level system units immediately bellow it.

FIG. 11 illustrates a typical a computer system being connected to a network. The control system and system unit of present invention are all comprises the typical computer system. The distribute control system and system units are connected to client systems over a said network via routers and switches.

### DETAILED DESCRIPTION OF THE INVENTION

Embodiments of the present invention are described herein in the context of the methods and apparatus for a new web user interface design by creating web-based multi-layers items list and to use it to manage and manipulate information and system resources of CCDSVM in the web-based computer user work environment. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

CCDSVM is an abbreviation for central controlled distributed scalable virtual machine. The CCDSVM allows a control management station to control one or more groups of systems and provide distributed services and applications to one or more client systems in Intranet and Internet as well as in LAN environments. The software components of CCDSVM form the virtual user operating environment.

Every computer system provides end users a computer work environment (CUWE), which usually runs on top of a generic computer operating system. The CUWE allows a first privileged user to setup account and authentication profile for one or more other privileged or regular users, to configure resources of storage, network, file system, file folders structure, files and all other available hardware or data resources on a system, to monitor system activities, to access applications, and to manage data files such as moving data from one folder to another folder or moving data from one system to another system, and to send or receive messages for communication etc.

Additionally, the CUWE provides one or more users each with limited permitted resources such as access to default file-folders on a file system, and other resources that each user can own. Furthermore, said per-user resources can be assigned to each user is based on the total number of users that a system can support. For example, if supporting a user login session requires an average of 2 Mbytes of memory and 512 Mbytes of storage, then to support 300 concurrent users on a system requires at least 600 Mbytes of memory and about 150 GBytes of storage space (not including the overhead in memory and storage required for the OS, the software that provides the CUWE, and other applications). Therefore, one or multiple users each can perform one or multiple tasks described above, which can run concurrently in the CUWE of each user after their successful login.

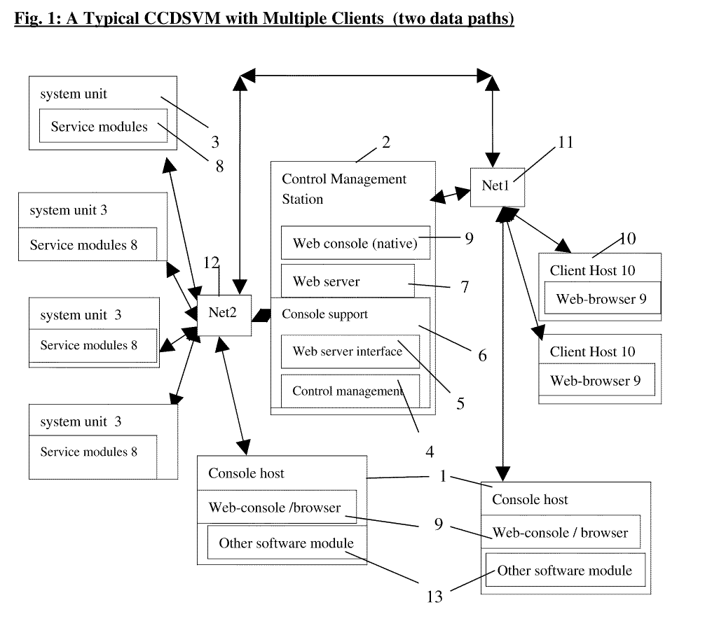

The web-based computer user work environment (WCUWE) of present invention is for a single or multiple computers in a virtualized environment. It provides one or more users from their web browser to run tasks that are compatible to tasks run on the native window based or command line based user work environment. Therefore, users from their web browser anywhere on the network can configure and manage the resources of network, storage, user security profile, file system structure, data and applications without limits. Also, the WCUWE provides each user's one or more tasks to be run concurrently in a web browser of the user. In addition, WCUWE allows each user to securely and concurrently login to the CCDSVM and work on one or multiple systems of the CCDSVM through a conventional web-browser either on a remote systems or devices such as laptop, PDA, desktop etc. or locally on native system such as control management system or system unit of FIG. 1. In one embodiment, the control system and each system unit have its own WCUWE, and the WCUWE of each system unit can be accessed via the WCUWE of the control system. In another embodiment, the control system coupled to each system unit to provide a single WCUWE. The WCUWE can also sometimes be viewed as a virtualized operating system. With this web-based computer user work environment the entire CCDSVM system can be operated like a single virtual machine.

The hardware resources on a computer or any other electronic device refers to the CPU, memory, storage device, network device, monitor or other display devices, keyboard, mouse, photo or video and audio recording and playing back devices, wireless device etc without limits; The resources also includes various forms of deposited data on storage, user accounts & security profiles etc. The deposited data on storage could be raw data or file system structure, which includes the file-folders, data or application program files, structured or unstructured data etc. The data files can be media data of streaming video or audio files including MPEG or AVI file, or image/photo picture data in various forms; document file such as MS Power Point or Word or spreadsheet documentation, PDF file, or text files and so forth without limit. The data files also includes records file, for example, in one embodiment, the message records file can contain one or more messages, and each message including multiple fields that comprises the information of sender, receiver, message body, data time, attachments of files or pictures. Also, in another embodiment, the multiple user account and authentication profiles also can be stored into a records file. The storage could be in any media form such as hard disk drive, magnetic tape drive, various forms of memory devices, or others suitable media. In addition, said resource also includes network resources such as the information of the name, IP address, ID, type of one or more systems on a network etc. The mentioned resource, storages, and deposited data are for illustration only, which shall have no limits with this invention.

Conventional web browser can interpret the standard structured format (formatted information) and display them with web pages, which can be encoded with any suitable or a combination of any suitable programming languages such C, C++, Java, JavaScript, HTML, XML, WML such that people can view, manipulate, and interact with the displayed information. The contents of a web page will be updated by server software on a server system, for example the control management station, in response to changing corresponding resource information on said server system. The web browser is a special network application software, which communicates with web server through protocols such as HTTP, HTTPS via a network or inter-process communication. The standard formatted information (web page) can be imposed and encoded by following the syntax of the programming language such as HTML (Hypertext Markup Language), XHTML, DHTML, XML, WML or any other various suitable languages, whichever can best describe the structured information. In the real life, these languages (HTML, XML, . . . ) themselves are often unfortunately referred to as standard format for web instead of as a language. Therefore, with present invention, it is not necessary to have a clear boundary between these two different entities. In other words, they are often be used interchangeably in this invention without further mention of the differences. Furthermore, the languages and protocols mentioned above are for illustration only, which do not impose a limitation in present invention.

The multi-layered item list (MLIL) is a logically organized information list with a certain order, where each entry contains an item and each item may contain another layer of listed items, where each items may represent a physical resource or information of the computer systems or other devices. For example, the information of files and file-folders of a file system or email folders on a modern computer system typically can be represented as multi-layered item lists and can be viewed, displayed & operated on a modern UI window of the native system, where each item (node) on the list may represent a folder or file. The information of systems or devices on the network, the information of hardware components on a system such as disks, network cards, memory etc., and the information of multiple user accounts on a system also can be organized into multiple layers of item lists for displaying, viewing, and operating. The support of the MLIL in the WCUWE makes the system resources and information much easy to be displayed, viewed, and operated from a web browser. Each web page provided by the WCUWE may contain one or multiple MLIL's. Each MLIL may contain at least one or more items (nodes) and so forth without limits.

All systems mentioned in present invention, are computational devices such as desktops, laptops, various types of servers such as web servers or database servers or email servers or video/audio servers or NAS or web application servers, wireless PDA, or cell phone or other devices with communication ability and with proper said computational resources and operating system (OS). Each system configures with one or more local file systems on top of one or more storage media and with corresponding data for providing services. The mentioned systems are just for illustration purpose and they are not limited in the present invention.

The OS mentioned in this invention can be any suitable operating system such as Windows, Linux, various Unix, real-time operating system and so forth without limits.

Programming languages, which are used for implementing all software mentioned in this invention, could be any suitable languages or a combination of the suitable languages. These languages are C, C++, Java, JavaScript, Visual Basic, C sharp, HTML, XML, DHTML, XHTML, and so forth without limits.

The communication protocols used in CCDSVM could be any type, which is appropriate for transmitting required data over a communication link, and they can be IP-based protocols or non-IP-based. The IP based protocols are built on top of IP protocols including standard protocols such as TCP protocol, UDP protocol, ICMP protocol, and others, and they also can be non-standard proprietary protocols. The non-IP based protocols can be ISO 8473, ISO 8208, or serial communication, or data link layer protocols like LLC 802.2, or HDLC, or any proprietary protocols bellow the IP protocol level. The communication protocols for web computing could be HTTP, HTTPS, SOAP, WAP, or others. The protocols mentioned above are only for illustration purpose and there are no limits in the present invention.

The web browser mentioned in this invention may be an existing commercial software from any vendor such as Microsoft IE or Netscape, or Firefox, or Mozillar, or any other commercial or proprietary software. The web browser must be able to handle web protocols such as HTTP, HTTPS, SOAP, WAP or others and be able to interpret the standard structured formatted information and must further to let users to view the contents transmitted over HTTP. The conventional web-browser and protocols described here are just for illustrating purpose only, and other web browser and protocols are all possible and are not limited in present invention.

The web server software mentioned in this invention could be a commercial software from any vendors such as Apache, IIS, or others on the market, and it also can be a proprietary software without limits. The web server software must be able to handle web protocols such as HTTP, HTTPS, SOAP, WAP and all other suitable protocols. Therefore, if the web-server software and web-browser are located on different systems, the structured information (encoded into web page) for the web browser can be transmitted to the web browser over communication link; if both web server software and web-browser are located on the same system, the structured information for the web browser can be transmitted to the web browser over inter-process communication.

A user session with a web system is normally started at the time the user logs in to a web system from a web-browser and ended at the time the user either voluntary or non-voluntary logs out of a web system from the same web browser that the user had logged into previously. During a session, users can perform permitted tasks.

FIG. 1 illustrates an embodiment of a CCDSVM platform being accessed by one or multiple clients. The CCDSVM includes console systems 1, control management system 2, provisioned systems 3, and networks 11-12, wherein networks 11-12 are used for inter-connecting with all systems of the CCDSVM and client systems 10.

Console system 1 is a computational system having a web-browser (web-console) 9 to be used by privileged users for accessing and managing the CCDSVM platform. Web browser 9, which could be on any system, permits a user to access information of the CCDSVM by following a web URL link. For example, a privileged user enters a URL of “https://690107.28.123/stt/sttwebos” on a command line of web browser 9 and once the link is established, the user can obtain information hosted by the web-based computer user work/operation environment (“WCUWE”). Console system 1, in one embodiment, further includes software modules 13, wherein modules 13 may be used to facilitate communication between console system 1 and control management system 2 using any suitable communication protocol.

The control management station 2, in one embodiment, could be any system with proper computational resources and suitable OS. The control management station 2 includes web server software 7 and console supporting software 6. The console supporting software 6 includes web server interface software modules 5, which are dedicated to communication with web server software 7 through inter-process communication, and control management software modules 4, which are dedicated to communicate with service software 8 of provisioned system 3 to further control and manage the provisioned system unit 3. In the rest of the discussion, the console support software 6 will be used instead of further mentioning web server interface software module 5 and control management software 4 since they both are part of console support software 6.

The control management station 2 may also have native Web browser (web-console) 9 of native system. The web server software 7 sends data to and/or receives data from web-console 9 of console hosts 1 or client 10 or control system 2 or provisioned system unit 3 by using any suitable protocols such as HTTP, HTTPS for web contents delivery. The web server software 7 and console supporting software 6 can be implemented with any suitable or a combination of suitable programming languages. In addition, the communication protocol used between console support software 6 and service software modules 8 of system units 3 could be any suitable protocol. The web server interface 5 of console support software 6 may be extended to provide service as web server 7 does, and in this case there is no specialized web server 7 software needed.

System unit 3 could be any system with proper said computational resource and OS and system unit 3 is provisioned by Control system. The system units 3 can be automatically provisioned by control system 2 through an automatic system service pool construction protocol described in said prior application of “Method and Apparatus for web-based Storage On Demand”. Provision process, also known as pooling process, is a method allowing control system 2 to control one or more networked systems by reconfiguring the network systems. For example, when a system unit 3 boots up via a communication protocol, control system 2 detects and obtains the system unit's name, ID such as group ID, IP address, and system information, which includes resources information including network information, storage information, file system information and so forth without limits. Also, the network information and the mentioned resources information of a system unit 3 will be stored into a system unit information list on the control system 2. Each provisioned system 3 can be monitored, accessed, and/or operated by a user(s) through web-browser 9 of console system 1 (or control system 2 or system unit 3 or client system 10). In an alternative embodiment, provisional system unit 3 is controlled by users through client systems 10 via control system 2 with proper users' authentication. System unit 3 can be dynamically added to or removed from service pool based on the capacity requirement of the CCDSVM.

Each system unit 3 contains service software modules 8, which is capable of communicating with the outside of world. For example, in one embodiment, the service software modules 8 of system unit 3 can communicate with console support software 6 of control management station 2 to carry out the tasks for viewing or operating on the resources of system unit 3. The service software modules 8 of the system unit 3 also can communicate with client 10 of CCDSVM to deliver data and services to each client directly without going through the control system 2 again and independent of other system unit 3. In another embodiment, a system unit 3 can communicate with other system unit 3 to send or receive data etc. in response to some tasks performed by the administrator, for example transferring one or more files from one system unit 3 to another.

The service software modules 8 of provisioned system unit 3 may include an individual software module having compatible functionalities of web-server software 7 of control system 2 and dedicated to handle HTTP, HTTPS protocol or other suitable web protocols if there are needs for web-based communication with client 10 or other system unit 3 or control management station 2. Said individual software module could be commercial web server software on the market or a proprietary software. The service software modules 8 could be implemented with any suitable or a combination of suitable programming languages; Also, the communication protocol used by service software 8 could be any suitable protocols.

In another embodiment, the CCDSVM can reserve one or more spare system units 3 for providing a central controlled fault handling functionality, where each spare system unit 3 may stored with mirrored data and application service program to provide dynamic data and service replacement for one or more similar type of system units 3 in an event that if the control system 2 detects any said similar system unit having a fault occur.

Net 11 and Net 12 are network infrastructures that are capable of providing communication links between control management system 2, console system 1, client system 10, and/or provisioned systems 3. The net 11 and net 12 may consist of connection media such as cable (Ethernet, optical Fiber, and other), wireless media for wireless link through the air, data bus on the circuit board, and it also consists of one or more piece of communication equipment such as switches, routers and adapters, etc. and all other possible elements of communication equipment so forth without limits.

Client systems 10 may not be a part of the CCDSVM, however, they are treated equally the same as Console system 1 because with the permission and authorization, users from web-browser 9 of client system 10 can login to the CCDSVM and access the permitted resources of the CCDSVM using web-browser 9 by following a web URL link of the CCDSVM. While privileged users can perform tasks of obtaining, managing, accessing and/or operating system resources from CCDSVM through WCUWE, regular (non-privileged) users at client systems 10 may be permitted to access only limited system resources of CCDSVM such as assigned personal file-folders or message folders. In addition, in one embodiment, the control system 2 keeps a client and system unit mapping list. The control system 2 adds the client into the map along with a designated system unit 3 that the client 10 is currently accessing. The control system 2 will remove the client from the designated system unit 3's mapping once the system unit 3 has finished deliver the data or service to the client 10.

The CCDSVM configuration, in one embodiment, includes four data paths. The first path is the data flow through the communication link between web browser 9 on client system 10 (or on console host 1 or on control management station 2, or on system unit 3) and the web handling software on control management station 2 such as web-server 7 & console support software 6. With this path of data, whenever the user sends a request from web-browser 9 to web-server 7 and further down to console support software 6, the console support software 6 will provide a response to said request by collecting all required information from the target system and convert them into standard structured information (encoded into the web page) by using any suitable or a combination of suitable programming languages such as C, C++, Java, Javascript, HTML, XML, WML and so forth without limit for web communication.

The targeted system could be any system unit 3 or the control management station 2 itself. The information collected for said response by console support software 6 of control management station 2 could be any type of resource or status information such as the system status, or the storage information, or the network information, or the user authentication profile, or the file system information or files & folders information on a target system, status of a task execution, and so forth without limit. Actually, said console support software can provide said response at anytime after receiving said request independent to the actual task result based on the application's needs, where said response could be the status of said task executing such as failed or finished or in progress, or the actual result of said task executing as mentioned in said prior applications. The console support software 6 then passes this converted structured information (web page) to web server software 7 and further transmits to web-browser 9 through communication link net1 11 or net2 12 so that it can be displayed and viewed by a conventional web browser 9.

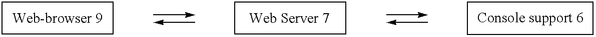

The communication protocol used between web-browser 9 of client host 10 (or console host 1 or control system 2 or system unit 3) and web server 7 of control management station 2 could be HTTP, HTTPS, or any other suitable protocols for web communication, which could successfully transmit the data on the web. This data path may be referred to as console support software 6 transmitting/receiving data to/from web-browser 9 without further mention web server software 7.

The second data path is the data flow through the communication link between the control management station 2 and system units 3. With this path of data flow, the requests targeted to system units 3 are passed from console support software 6 of control management station 2 to service modules 8 of system unit 3 through the communication link 12. If the responses for those requests must be returned back to control management station 2, the service modules 8 of system unit 3 will carry out the requests; and if there is need, then send the response back to console support software 6 of control management station 2. The communication protocol used between console support software 6 of control management station and service modules 8 of system unit can be any suitable protocols. The typical data flow through this path could be the boot message or system status or network information or storage information of system unit 3, and so forth without limit.

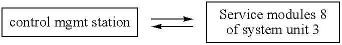

The third data path is the data flow through the communication link between provisioned system unit 3 and the client system 10 or console system 1 via communication link 11-12. Refer back to FIG. 1, in one embodiment, the console support software 6 of control management station 2 may present a web link (or a point), which points to an object on provisioned system unit 3, to the user on the web-browser 9 of client host 10 (or console host 1 or control management station 2). The object pointed to by the web link on the provisioned system unit 3 could be a file of text, streaming video or audio, PDF, MS power point or Word documentation, and so forth without limits. It also could be a link to another web service program file. From web browser 9, the user can directly access the information on provisioned system unit 3 pointed by the web link without going through the control management station again via a specialized communication protocol, in one embodiment, it could use the method of download, in another embodiment, a special file transferring method can also be deployed. In this case, the service modules 8 of system unit 3 also includes a web server software 7 or equivalent software to support web browser 9 direct accessing of said file content without go through control system 2 as mentioned before. Therefore, each provisioned system unit provides file service or application service independent of other provisioned systems and provides said service directly to client to avoid the control system to be a performance bottleneck. For simplicity, the data transmitted on this path will be referred as service software 8 that send data to or receive data from web-browser 9 and vice versa.

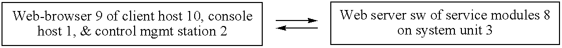

The fourth data path is the data flow through the communication link between one system unit 3 and another system unit 3. With this path, in one embodiment, the service modules 8 of one system unit 3 can directly transmit data or information to service modules 8 of another system unit 3 via a communication link 12 without going through control management station 2. The communication protocol between system units 3 could be any suitable protocol. The data and information transmitted through the path 4 can be various type such as a data file. For example, an user on web-browser 9 may walk through a file folder on a system unit 3. Later, the user instructs to transfer a file or a file-folder from current target system unit 3 to another targeted system unit 3 by a click, therefore, the data file or a file-folder will be transferred directly between two system units 3 without going through the control management station 2 again.

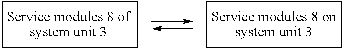

This typical CCDSVM configuration combined with the WCUWE can provide web-browser based enterprise global IT management. Furthermore, it creates a global scalable secure file server, which is a base for various web based distributed application services pools. For example, a user can build unlimited web-based video on-demand on top of it and can build other unlimited on-demand services.

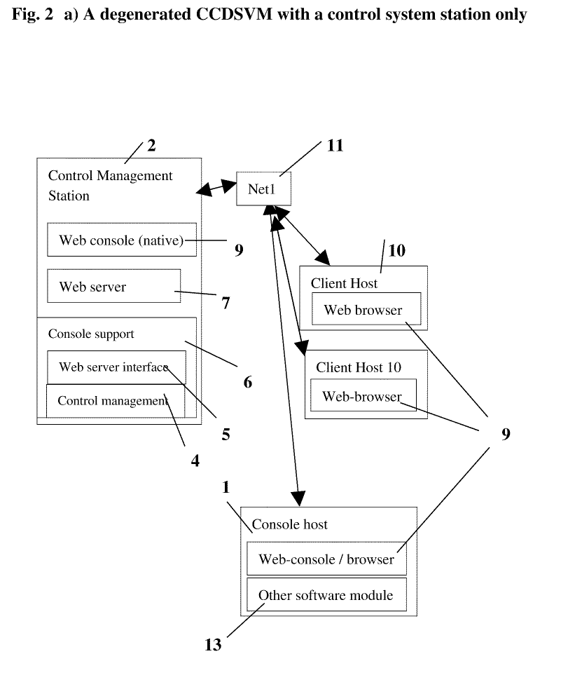

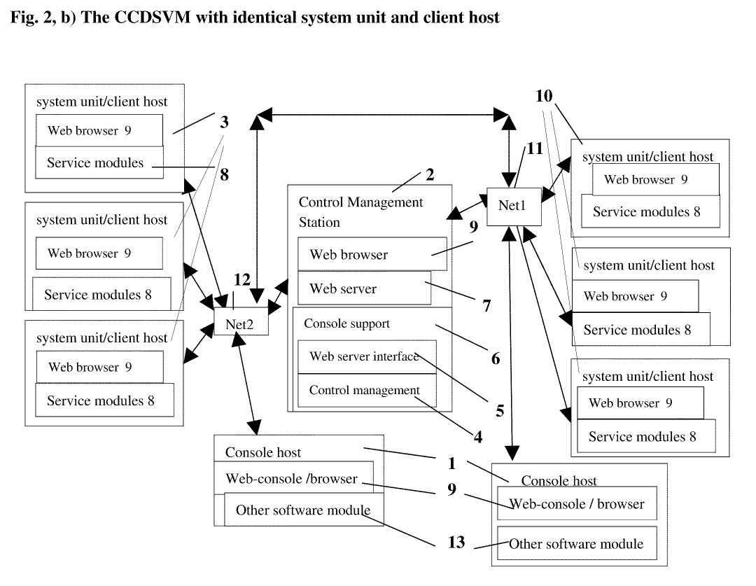

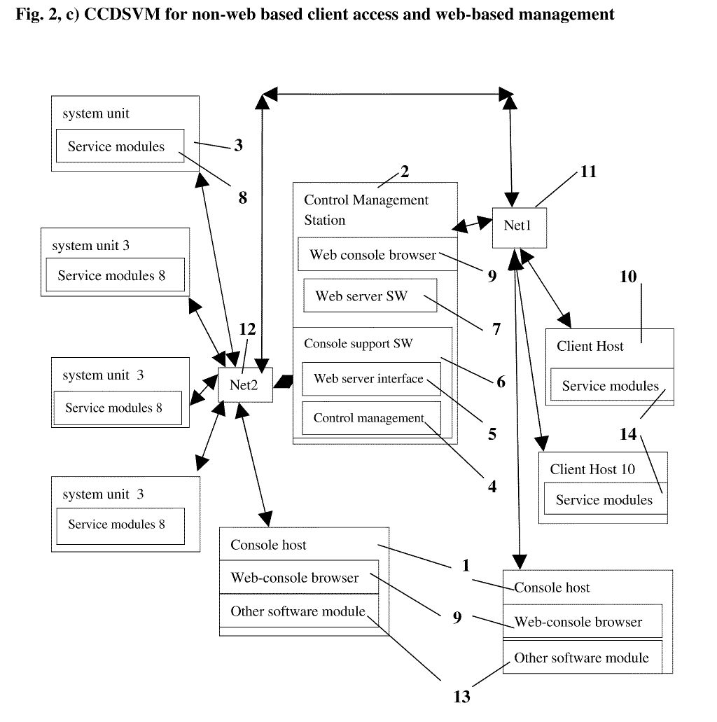

FIG. 2 a) illustrates an embodiment of a variation of CCDSVM platform, which configured only with a single control system 2 and without any provisioned system unit 3. With this model, the CCDSVM is degenerated to a single standalone system and the control system 2 can run on its own with WCUWE. Therefore, the user from the web-browser 9 of the console system 1 or client 10 or control management station 2 can access and operate the entire resource on control management station 2.

FIG. 2 b) illustrates a variation of CCDSVM platform in accordance with one embodiment of the present invention, This model is exactly same to the typical CCSDVM as shown in FIG. 1, except there is no difference between client host 10 and provisioned system unit 3 since each system unit 3 is also configured with a web-browser 9 and each client host 10 also configured with service modules 8. In this model, with security permission, users of each provisioned system unit/client system, can login to control management 2 from a web-browser 9 and further access & operate the resources of control management station 2, or any other system unit/client 3.

FIG. 2 c) illustrates another variation of CCDSVM in accordance with one embodiment of the present invention. This model is the same to the typical CCDSVM as showed in FIG. 1, except that the client host 10 has its own service modules 14 for non-web based access instead of using a web-browser 9 for accessing. For example, in one embodiment, if system unit 3 is a SAN unit providing storage volume and the service modules 14 of client host 10 is a driver routine for reading and writing data from/to the disk volume on system unit 3. In another embodiment, the service module 14 is a networked software application provides a non-web browser based networked UI for users to access the CCDSVM, and the software modules of the control system 2 and each system unit 3 communicate with service modules 14 of the client system 10 using non-web protocols. The client host 10 may also have a web-browser 9 for purpose of accessing system unit 3 other than reading data from or writing data to disk volumes.

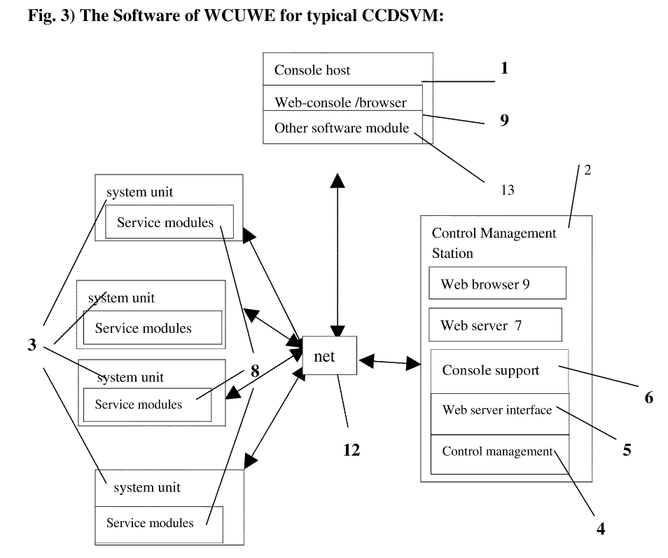

FIG. 3 illustrates the software of WCUWE in accordance with one embodiment of the present invention, which can be implemented with any suitable or a combination of any suitable programming languages such C, C++, Java, JavaScript, Visual Basic, HTML, XML, etc. and so forth without limits. The software of WCUWE may include software modules on control system 2 (web-browser 9, web server software modules 7, console support software modules 6, web server interface modules 5, and control management software modules 4), software modules on provisioned system unit 3 (service software module 8), and software on console system 1 (web-browser 9, other software modules 13).

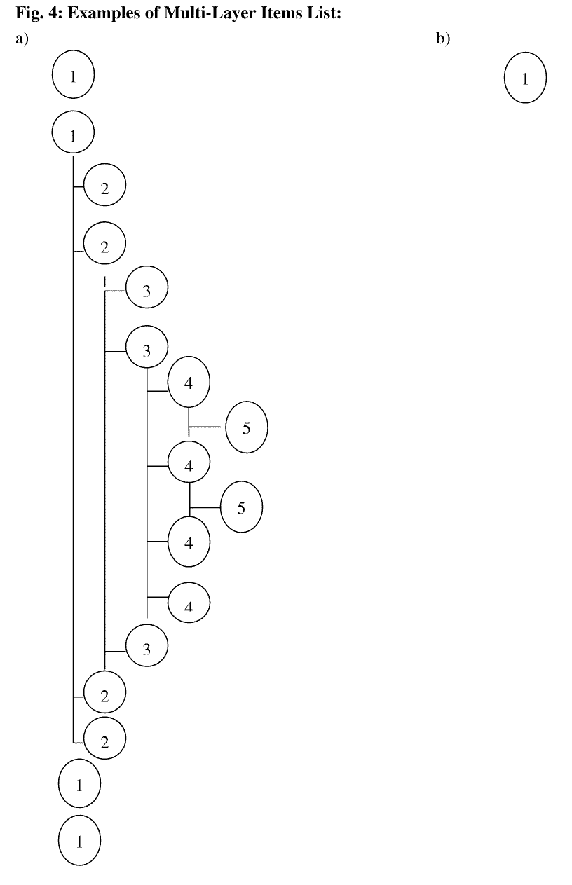

FIG. 4 a) illustrates a simplified example of multi layered item list (MLIL) in accordance with one embodiment of the present invention. This MLIL is organized with 5 layers and 18 nodes, wherein each node can be associated with, and represents a particular resource of the CCDSVM. One or more nodes can be added or deleted at each layer of said MLIL depending on the nature of the operation on the corresponding said resources of CCDSVM. If any resource node contains sub levels of resources, a corresponding selected node can be expanded to display the next level of sub resources, which will actually result in adding one or more new subsequence levels of nodes to display one or more corresponding said sub resources under the current node. Also, the expanded sub-nodes can be collapsed by selecting and clicking on the current node, which is similar to manipulate a node of an MLIL on a native window based system, and the sub nodes will be dynamically deleted.

There is no limit on how many number of nodes and layers of MLIL can exist in the present invention, which basically depends on the system's total capacity. The nodes of a MLIL can be dynamically expanded or reduced depends on user's accessing and operations. In one example, if a user adds a file folder on a MLIL for file system tree, or if a new system unit boot up to be added into the MLIL for network information tree, the nodes on the MLIL will be expanded accordingly. In another embodiment, if a user deletes a file in the file system tree on an MLIL or if a storage device being deleted from a system resource tree of an MLIL, or a system is removed from a network, the nodes of the corresponding MLIL will be reduced accordingly. In another embodiment, if a user is walking through an MLIL file system tree and trying to collapse a file folder, which has one or more displayed sub file-folders or files, the MLIL will be reduced along with deleting said one or more nodes on the MLIL for corresponding said sub file-folder or files. In addition, one or more said MLIL can be encoded into a web page for displaying.

FIG. 4 b) illustrates another example of multi layered item list (MLIL) in accordance with one embodiment of the present invention. This MLIL only contains one node and 1 level of the layers.

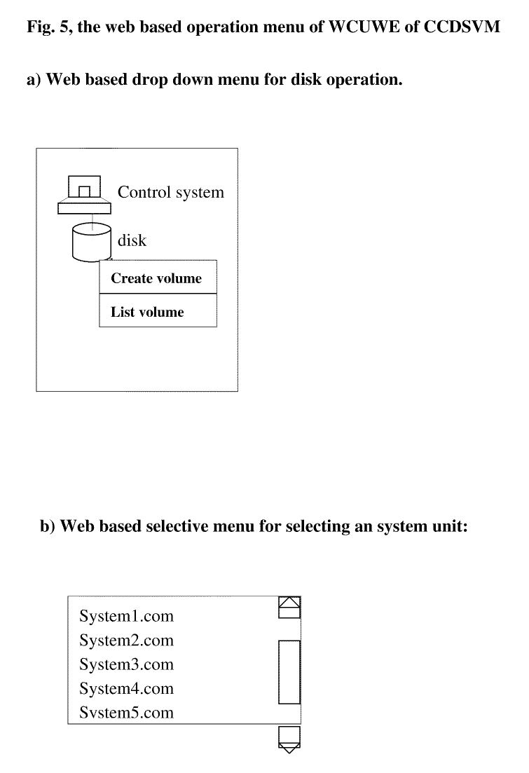

FIG. 5 a) illustrates an example of a web-based pop-up operation menu for disk volume management for storages on system of CCSDVM in accordance with one embodiment of the present invention. Said pop-up operation menu is bound with a disk node on the MLIL, which is also associated and graphically displayed through a disk graphic image.

FIG. 5 b) illustrates an example of a web-based selective/drop-down operation menu for selecting a system of the CCSDVM as a first step of performing tasks on the selected system in accordance with one embodiment of the present invention.

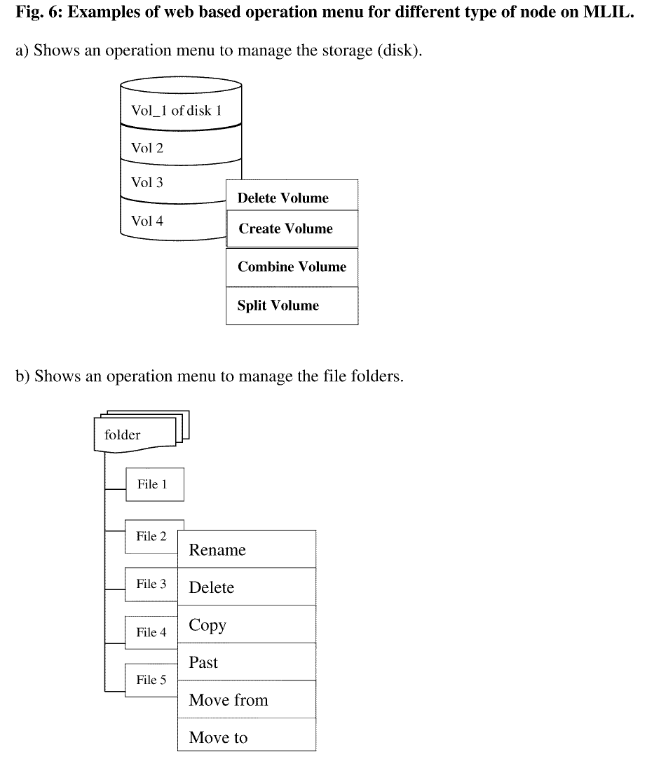

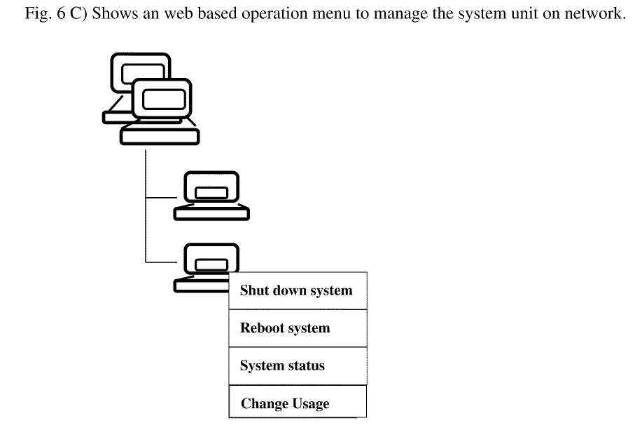

FIG. 6 a) illustrates a web-based pop-up operation menu designed for storage volume management for a node of MLIL associated with a disk storage on a system of CCDSVM in accordance with one embodiment of the present invention.

FIG. 6b) illustrates a web-base pop-up operation menu designed for managing files and file folders, which bound to each node of an MLIL associated with files or folders on a system of the CCDSVM in accordance with one embodiment of the present invention.

FIG. 6c) illustrates a web-based pop-up operation menu designed for management of the control system and provisioned system units, which are associated and represented by multi-layered nodes of an MLIL in accordance with one embodiment of the present invention.

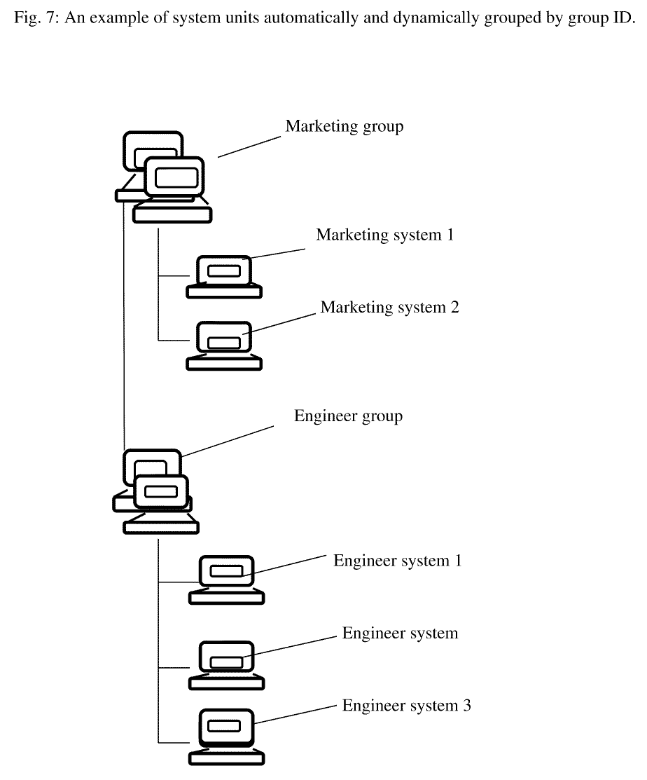

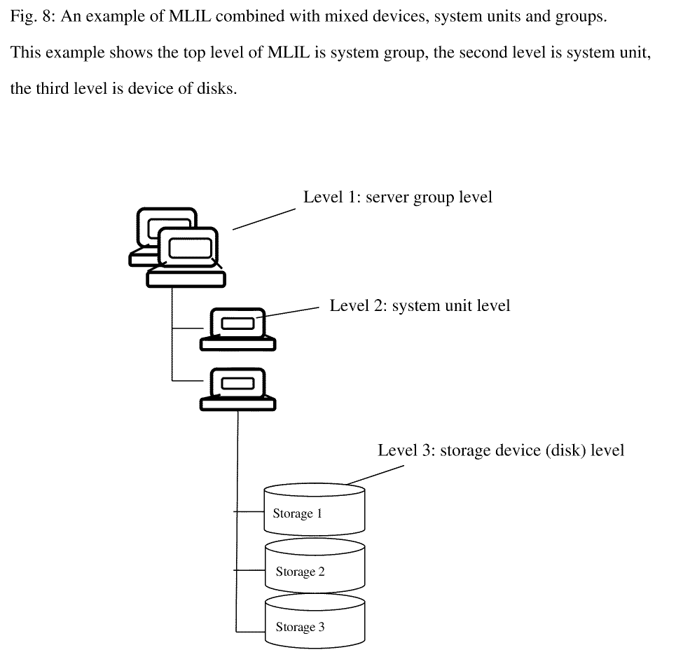

FIG. 7 illustrates a web-based MLIL used for displaying provisioned system units, which are automatically & dynamically grouped by group ID, and associated & represented by multi-layered nodes of an MLIL in accordance with one embodiment of the present invention. FIG. 7 provides an example of five provisioned system units, which are divided into two groups that are titled “marketing group” and “engineer group”. The marketing group contains 2 system units while the engineer group contains 3 system units. The groups are automatically and dynamically formed when system units boot up.

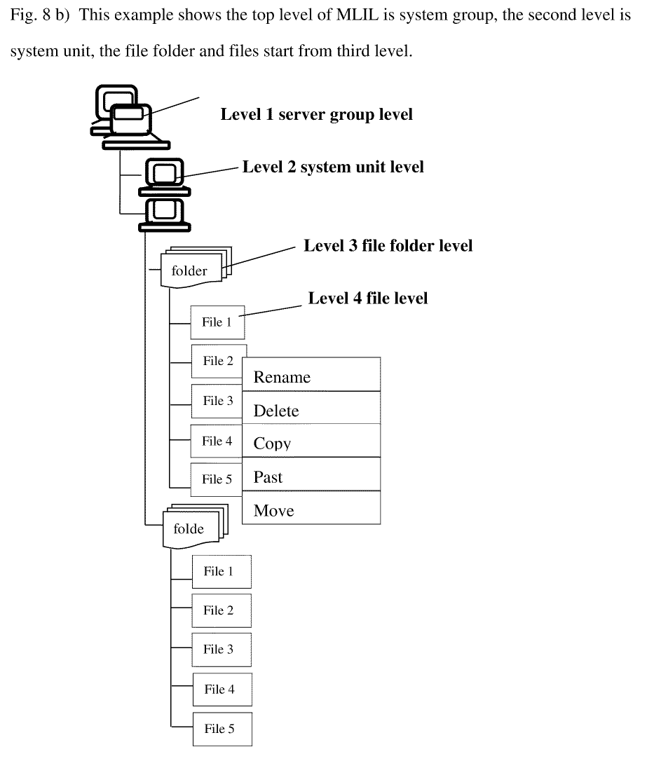

FIG. 8 a) illustrates a web-based MLIL used for displaying the system group, provisioned system units, and storage devices that are associated and represented by multi-layered nodes of an MLIL in accordance with one embodiment of the present invention. Said MLIL has been organized with 3 layers and 6 nodes, wherein, the first level is the server/service group level (one node), the second level is the provisioned system unit level (two systems are associated with two nodes), and the third level is the system resource level (three disk storage devices are associated with three nodes in this example).

FIG. 8 b) illustrates a web-based displaying of a system group, provisioned system units and files & folders, which are associated and represented by multi-layered nodes of an MLIL in accordance with one embodiment of the present invention. Said MLIL has been organized with 4 layers and 15 nodes, wherein, the first level is the server group level (one node), the second level is the provisioned system units level (two provisioned system units are shown), the third level is the system resource of folder 3 (two folders in this case), and the fourth level is the file level (each folder contains five files). Also an pop-up folder operation menu has been brought up and is displayed.

The FIG. 1 will be used for most of the discussion of the present invention unless otherwise specified by another figure number. The FIG. 1 illustrates the web-based computer user work environment (WCUWE) of the CCDSVM provided by the software of WCUWE FIG. 3, which includes console support software 6 & web server software 7 on control management station 2 and service modules 8 on system unit 3.

The WCUWE of the CCDSVM can be initiated by the software modules of the WCUWE FIG. 3, especially the console support software 6 of control management station 2 as followings:

The console support software 6 collects and maintains one or more information lists of said major resources of the control management station 2, which can be converted to said standard structured format (formatted information) that is the web page encoded with the resources information, which is viewable in a web-browser 9. The resources can be collected whenever the control management station 2 boots up or at other appropriate time such as upon a user to access one or more corresponding resources. The resource information list may be stored in memory for fast retrieval at a later time and also may be stored on permanent storage such as disks.

The console support software 6 communicates with service modules 8 of provisioned system unit 3 to collect all said major resources information of each system unit 3 through a communication link 12. Furthermore, the console support software 6 adds the collected information of system units 3 into a network information list on the control management station 2. In addition, upon users' accessing, said network information list can be organized with an MLIL and converted to a standard structured format (web page) for web communication that is to be transmitted to web-browser, therefore, they are viewable in any web-browser 9. The network information include said resource information such as the system units 3 and its hardware and data resources without limits. The network information can be collected whenever the system units 3 boot up or at any other appropriate time, such as, when a user perform a task or access a resource node on an MLIL.

Further, the network information of the control management station 2 can be kept in memory for later fast access and can be organized into any suitable logical structure, for example, organizing as a simple list of array, linked list, double linked list, hash table, tree structure, etc., without limit. The network information also can be stored on permanent storage such as disk or other type of storage for the backup purpose, and can be stored in an appropriate form, including various commercial databases, binary record file, flat text ASCII file, and so forth without limits.

The console support software 6 of the control system 2 also provides the first privileged user to create one or more other privileged or regular user accounts and store user account profiles into the database. The user account profile comprises information of user account name and password, user's role and credentials, security permission to access one or more resources, and also comprises a point or a link that points to a user access records file, which recording the information of which person, at what time, and from where, performed what tasks, and accessed what the resources. Said first privileged user is created during installing console support software 6 on the control system 2.

In one embodiment, a privileged user from a web browser to create a new user. The console support software of the control system facilitate a web page including one or more input areas to specify user account name, password, an IP address from where the new user is permitted to access the CCDSVM. Also the privileged user can specify one or more targeted systems in one or more targeted service groups (system groups) that the new user can access. In addition, it includes an user credential area to specify each user's role such as super user or system user or general user, to specify the specific tasks can be performed such as configuring system or monitoring system or creating authentication for user or transfer filing between systems of CCDSVM or shutdown the CCDSVM, to specify what type of application program files or data files the user can access without limits. Actually, each user's security credentials, access permissions, and authentication information are encoded into each corresponding field in a data structure and to be stored in the database.

In another one embodiment, the console support software 6 of the control management station 2 facilitates a centralized user security authentication management. This includes facilitating privileged users from web browser to specify the operation type including creating new privileged or non-privileged user account, displaying the current permission and authentication for a specific user, deleting a user account, modifying and updating password, the permission that specifying from where that user can access CCDSVM, displaying the system group that a user is permitted to access or manage, and displaying one or more system units in a system group that is permitted to be accessed.

Users from web-browser, which could be on client system 10 or console system 1, or control management station 2 or system unit 3, can login to the CCSDVM via a web URL link to access a login web-page provided by the console support software 6 of said control system 2. After the login, console support software 6 of the control system provides displaying one or more resources information including accessible one or more service programs or data information into each user's web browser based on each user's security credential and permission. Therefore, each users from his/her own web-browser 9 can interactively obtain resource information and perform tasks of accessing one or more resources information on control system 2 and on each system unit 3. The WCUWE provides concurrent login users each from a single web-browser 9 with the ability to perform multiple simultaneous tasks over said resources of the CCDSVM while providing secure protecting for said resources during accessing by one or more users.

The tasks, which can be performed and run in said web browser, are compatible to tasks that can be run on either native window based or command-line based computer user work environment such as discussed in said prior applications of “Concurrent Web Based Multi-Task Support for Control Management System” and “Method and Apparatus for web-based Storage On Demand”.

In order to provide convenience for each login user to perform tasks in WCUWE, the console support software 6 may alternatively use a logical structure of multi-layered item list (MLIL), as shown in FIG. 4, together with an associated web-based operation menu (FIG. 5) for managing the actual multi-level organized resources of the CCDSVM. The resources as mentioned before could be the files or file folders of a file system, a list of provisioned system units 3 on the network, or the users and their security profile etc. without limits. If there is a need to create a structured multi-layered item list (MLIL) for resources on target systems, the console support software 6 of control management station 2 will perform the following actions:

a) For each login sessions of each user, a memory management module of the console support software module 6 creates one or more MLIL in response user to access one or more corresponding resources, wherein each node of each MLIL can be flexibly expanded or reduced or collapsed during on-the-flying operating for a corresponding physical resource. The user can expand a node of a MLIL by selecting and clicking on the node as long as there is a next level of one or more resources; the user can collapse a previously expanded node of an MLIL by selecting and clicking on said node; A node of a MLIL can be added or deleted in response to said user to perform corresponding tasks via said operation menu; Further, the console support software 6 creates an association between each created MLIL and the actual targeted physical resources. The created MLIL can reside in memory and can be in any form of a list structure such as a simple array list, link list, double link list, various tree structure, or hashed table, etc. without limits. Since the memory management module is part of the console support software modules 6, for the convenience of discussion, in most cases, only console support software modules 6 will be mentioned instead of mentioning memory management module if creating, updating, deleting, etc. for said MLIL is performed.

b) For each created MLIL, binding an appropriate corresponding graphic image or text description to each node (item) on the MLIL for the purpose of visually displaying; and binding each nodes (items) of the MLIL with their appropriate attributes. The attributes of a resource could be the name, ID, size, type, timestamp, ownership (access permission), location, and other information of a physical resource object. The attributes shall reflect the nature of the actual resources such as name, type, level, size of said resource etc. and so forth without limits, therefore, the resources can be encoded into the web page and correctly displayed through MLIL.

c) For each created MLIL, binding an operation menu to each node of the MLIL. The operation menu can be either a web-based pop-up menu or a drop-down selective menu such as shown in FIG. 5, or just one or more submit buttons. Each operation menu comprises one or more operating options, wherein each operating option is associated with a specific task for the corresponding resource information of an MLIL.

d) Convert each created MLIL and all associated information of MLIL, (such as graphic or text presentation, operating menu, attributes of said resource etc. without limits), into said standard structured format for web communication such as encoding said information of MLIL into a web page to be displayed in a web-browser 9. The converted information of the MLIL in a web page will be transmitted from console support software 6 of the control system 2 to said each users' web-browser 9 on the control system 2 or on the client system 10 or on the console system 1 or on the system unit 3, therefore, the physical resources represented by per user MLIL and all associated information can be viewed and operated by all users from each of their own web-browser 9 via each user's MLIL. The converted logical item list can be transmitted using web protocol such as HTTP, HTTPS or any other suitable protocol in order for users to view it from a web-browser 9.

e) After performed and submitted a task of viewing, accessing or operating said resources of the CCDSVM by each user via selecting displayed information of an MLIL in a web browser, the console support software 6 of the control system 2 receives, parses and stores each task information into an available slot of a user space task list; distributed each task into background and arranges said tasks to be run on one or more targeted systems. Further, the console support software 6 may update the information of each MLIL in memory and update the corresponding web-page encoded with MLIL in a web browser based on the status and the results of the task execution. In one embodiment, the control system obtains status or result of a task from one or more targeted system units via the network.

Also, said memory management module of console support software 6 keeps tracks of memory usage and status for each correspondent MLIL, which may be expanded or collapsed along with said tasks being executed with said resources. For example, the task of deleting a file or folder requires the deletion of the actual file or folder on a designated system and the corresponding one or more nodes and associated information on the MLIL. In another embodiment, the task of adding one or more file-folders/directories will require to add one or more nodes into the MLIL as well as adding the actual physical one or more file-folders into a file system. In another embodiment, the operation of listing next level of one or more sub-node, will add one or more nodes into the MLIL without affecting physical resources. The console support software modules 6 will update the web page in web browser to reflect the updated information of said MLIL.

More importantly, all processes or threads of a user session created to perform tasks of operating physical resources represented by the MLIL can effectively share the dynamically modified MLIL with a consistent view throughout the each users' entire login session. This requires said memory management module of the console support software 6 to dynamically translate and map the initial memory address of an MLIL of a user session to another logical memory address in each process/thread of said user session during each user's interaction in performing task, therefore, the different processes or threads of the same user session can effectively access and share the same physical memory object of a dynamically modified and updated MLIL during the user session. The console support software of control system will also clean up the corresponding task information stored in slot of said user space task list after said task execution is completed.

In addition, one or more locks may be used for protecting resources associated with executing each task such as for a user space task list, the resource that said task immediately operating on, and other resources related to the task execution without limits. Using lock to protecting resource shall be regarded as default action for task execution in present invention and will not further be mentioned in details. The steps described from b) to e) above can be repeatedly processed as long as user keep working on same resource represented by a specific MLIL.

f) For each user who voluntary or non-voluntary logged-out from the CCDSVM to end his/her login session, each created MLIL of the user session will be deleted by the memory management module of the console support software 6.

The accessing and managing file system has always been an important part of any computer user work environment (CUWE) in the past. Supporting a file system to be accessed by users from a network has always been a challenge to many vendors. The parent applications of the present invention have disclosed that users can perform tasks such as managing storage volumes of an entire CCDSVM from a web browser 9, and creating, managing, and accessing the file system on either control management station 2 or each system unit 3. Also, a file system on the control system or system unit can utilize a storage volume on different IP SAN or non-IP SAN. As matter of the fact, CCDSVM can provides a virtual file server pool with one or more file systems of one or more system units to utilize storage volumes in the storage volume pool within the same CCDSVM.

In addition, users can perform all file and folder management tasks such as add new folder, or delete and rename file or file folder, copy/paste and move file or file folder without size limit either between locations on a same target system or cross one or more systems. With the combined MLIL and operation menu forming a web-browser based new UI, which is particularly suitable for file systems of the CCDSVM, users can more efficiently perform said tasks of accessing and managing files and folders, and file systems on systems of CCDSVM from web-browser 9 on the flying without caching anything.

With new UI, the multi-layered item lists (MLIL) being used to represent the actual file & folder structure of the file system on a target system of CCDSVM, where each node of an MLIL may represent a file-folder or a file system or a file. When a user from a web-browser 9 walks through the displayed file system of an MLIL by selecting and clicking on one node at a time from the MLIL to view or operate each file or file-folder or file-system via operation menu, only a small piece of information, which relates to the file or folder or file-system being operated on, needs to be retrieved or transmitted between a target system of CCDSVM and control management station 2.

For example, if a user wants to add or delete a node such as a file folder node on MLIL, the only major information needed to be transmitted from the control management system 2 to the target system is the folder name, and the target system shall carry out the task. Also, said console support software 6 of the control system 2 will update said MLIL and related information encoded in a web page for the web browser after the task is executed, and furthermore the web page encoded with said MLIL will be updated and refreshed in the web browser.

If a user wants to access the information/resource, which is bellow the current node on the MLIL, such as the resources bellow a file folder, the only information need to retrieve from target system is the attributes of sub-folders and files if there is any under the current said folder. The attributes of a file or file-folder are the name, size, type, timestamps, ownership with security permission for read, or write, or both read and write, and the location of a file such as located on which system and its path etc.

If a privileged user wants to set access permission for a file or a file-folder on any of target system via the displayed MLIL for one or multiple targeted users to access, the information of said target system and the information of the file or folder need to be added to and bound with each user's account profile. The privileged user can browser and select a targeted file or file-folder, then setup said permission for targeted user via an operation menu with an operating option of set access control together with an inputted information of a targeted user.

On the other hand, if said privileged user wants to revoke previously granted permission for a targeted user, privileged user can delete permitted file or file-folder information from targeted user's account (security) profile in the user account profile database by browsing and selecting said targeted user account through the displayed user account profile database. The target systems could be either control management station 2 or system unit 3 of CCDSVM. The present invention has created a method of displaying one or more file systems on one or multiple systems without caching any actual files, file folders, and file systems. Meanwhile, the web page displaying said MLIL can be updated quickly in real-time in web browser in response to the users performed tasks of accessing and managing file system, and its files and file-folders.

The different types of files can be organized and displayed differently via the MLIL based on the usage of the file. In one embodiment, a tope level of a message record file can be organized with second level nodes of sent, received, deleted, drafted, and/or according to the nature of the message such as news, business, health, sports, etc., and each individual message nodes can be listed at third level etc. without limits. In another embodiment, a tope level of each user's secure access records file can be organized at second level nodes according to departments' or projects' requirements, and each individual user's access records can be organized at third level, and each individual records of each individual user can be organized at 4^{th} level, and so forth without the limits.

In one embodiment, ff users need to view or edit the content of a file on a system unit 3, the file may be transmitted via a communication link 11-12 directly from the target system unit 3 to the client system 10 or console system 1 or control system 2. If the file is on control management station 2 and users like to view or edit it from a remote system, the file is transmitted via communication link 11-12 from control system to a web browser on the client system 10 or console system 1 or system unit 3. the is required to be converted from the original format to another format, which may be viewable and editable in said web-browser 9.

With a proper viewing tool on a client host 10 or console host 1 or control management station 2, which may be invoked from the web-browser 9, the user is able to view the contents of the file. With a proper editor, a user can further edit the file and then transmit the file back to the target system, which could be either the system unit 3 or control management station 2.

In one embodiment, the file may also be transmitted from the target system to the control management station 2 and then be converted from the original format to another format, which may be viewable and editable in said web-browser 9. After conversion, said file may be transmitted from said control system 2 to a web browser on the client system 10 or console system 1 or control system 2 for viewing or editing within a web-browser 9. If the target system is the control management station 2, there is no such transmission required.

Network information also is an important part of the WCUWE of the CCDSVM. With the mentioned parent application, each system unit 3 of the CCDSVM of the present invention can be automatically and dynamically provisioned into one or multiple service groups based on the system unit's group ID and system name and IP address across LAN/WAN, Intranet and Internet, where each group contains at least one provisioned system unit 3 for provide a dedicated service to the clients 10.

To effectively access and manage the automatically grouped system units 3 and their associated hardware and data resources, the multi-layered item list (MLIL) also can be used. In one embodiment, the mixed information of CCDSVM on the network can be ordered with top-down fashion from server-group at the top level, system units 3 at second level, and hardware devices or file system starting from the third level on said MLIL, and so forth without limits.

More specifically, each node on the MLIL with a different level or type may associate with a different type of operation menu. For example, a node of provisioned system unit 3 on MLIL may associate with an operation menu containing system status, shutdown, storage management, change system usage for service operations etc without limits; and a node of storage device may associate with an operation menu of creating storage volume, displaying storage volume, and delete storage volume, combine storage volumes or split storage volume; a node of file or file folder may associate with an operation menu containing add, rename, delete, copy/paste, move etc. so forth without limits. After each said operation, the corresponding web page will be updated correspondingly independent of the final result, said responding web page may encoded with either a status of operation such as fail or in progress or success, or a location of the result to be placed or an actual result of said operation, or the result itself.

After said conversion of all information associated with the MLIL, to said standard structured format, that is to encode said information of MLIL into web page, the complex information on the network can be viewed and operated much more easily by users from a web-browser 9 via the orderly selecting and clicking mechanism. For example, FIG. 7 shows the system units 3 are provisioned into multiple groups. FIG. 8 shows the example of how a device such as storage is listed under server units 3 in each group can be accessed and managed. FIG. 9 illustrates how the file system on system unit 3 in a group can be accessed.

With the method of automatically and dynamically grouping system units 3 and wisely use the MLIL to represent the diversified resources on network, the entire CCDSVM can be much more efficiently accessed, operated, and managed. For example, in one embodiment, by simply selecting and clicking on a storage node of a targeted system on the MLIL displayed in a web-browser 9, privileged users can create storage volumes from a fresh disk on any target system and make file system, mount file system and create folder structures on the top of actual storage object, and further setup access control for user with limited privileges.

Following similar steps of set access control over a file or file-folder to be accessed one or more targeted user, the privileged user can easily setup access control for system groups, each system unit, and each resources other than the files and file-folders to be accessed by one or more targeted users. In one example, privileged user can browse to a system group node and setup access permission for granting targeted users to access all resources of said system group via an associated operation menu; or can browse to a system node and setup access permission for granting targeted users to access all resources of a specific system via an associated operation menu; or can browse to a specific file-folder node of a specific file system on a specific system and setup access permission for granting targeted users to access one or more sub files and folders under said file-folder; or can browse to a specific device node such as a network cards or a storage device and setup access permission for granting targeted user to manage such devices, and so forth without limit.

Said granted and permitted resource information will be bound to targeted user's account profile and to be validated after user login to the CCDSVM and upon user performing task against the resources of the CCDSVM. The granted security permission also can be revoked via an operation menu with the same steps as described in removing security permission for accessing file or file-folder before. In another embodiment, the granted security permission can simply removed from the user's security profile. Therefore, the WCUWE can let targeted users securely access resources on a global network from a web-browser 9 on a client system or console system or control system or any system unit, anywhere around the world.

Initially, said WCUWE allows a default super user to login to the WCUWE of a CCDSVM and to access the authentication web-page provided by said console support software 6. Therefore, the privileged super user can setup other privileged or non-privileged users' account and their profile thereafter. Similar to file system in WCUWE of CCDSVM, the users' account and profile also can alternatively be viewed and operated on using a MLIL. Combined with a web-based operation menu such as illustrated in FIG. 5, users' account and profile can be further converted to said standard structured information (encoded into a web page), which can be viewed and accessed by said privileged users from a web-browser 9.

Therefore, through selecting and clicking on the MLIL of a user profile and web-based operation menu in a web page, a privileged user can conveniently perform all compatible tasks that normally require more steps to perform if without using MLIL for user authentication management. Said tasks include creating the user account and profile, viewing, updating, or deleting user account profile and other operations, so forth without limits. Specially, the privileged users can setup profiles for other non-privileged users for secure access control. The security permission for users to perform tasks includes those discussed in said prior patent applications. In addition, the user information and their security profile can be kept in any form of a database, which could be a commercial database on the market, or a plaint text file, or a binary record file, or others without limits.

Having said web based MLIL to be used in web based computer user work environment, the web browser is only a network application, therefore, the MLIL can actually be used in any networked application to provide a efficient networked user interface for a server by deploying other special communication protocols including other specialized TCP/IP/UDP protocols other than web protocols such as HTTP or HTTPS. Specially, it can be used by a non-web based networked computer user work environment.

Also, in one embodiment, the service software modules 8 of the system unit 3 can include equivalent functionality of the console support software 6 of the control system 2 for support MLIL. Therefore, each system unit is capable to provide its own web based user work environment to include the support of the MLIL in response to each user's access and manage the system unit either directly or indirectly from the user's web browser 9. Therefore, in one embodiment, each system unit 3 can provide application service or data service to each client; and in another embodiment, each system unit 3 can provide an WCUWE to each user from web browser to access and manage the resources of the system unit 3. In addition, such system unit 3 can access, monitor and manage another layered one or more system units 3 in a larger CCDSVM environment as depicted in FIG. 10.

With layered CCDSVM infrastructure, the middle level system unit is also the middle layer of control node, which keeps a information list of next level system units immediately bellow it. The information list of next level system units can be collected by the top or middle level control node at the boot time of each system unit and further to form a group. At top level, there is a spare control system, which can provide replacement for service in case of the top level control system having fault. Also, at each group level controlled by a middle level control node, there is at least one system unit can be used as spare system unit for providing replacement for any fault system unit in that group. In addition, each system unit in a group can be dynamically added or removed.

In one embodiment, each user's authentication and privilege scope can include assigning to access a specific group of system at a specific level only or assigning to access systems in one or more group of system units bellow the current assigned group level but not above. This will greatly enhance the integrity and security of a larger infrastructure of virtual machine. As matter of the fact, each middle level system unit or control system can provide one or more users a central access point to access one or more system units bellow said middle level system unit or control system.

Much have being discussed, now let us discuss more on the typical computer systems in present invention is depicted in the example of FIG. 11, the distribution control station (2) comprises a computer system (15) which includes a bus (102) or other communication mechanism for communicating information, and a processor (CPU) (104) coupled with the bus (102) for processing information. The computer system (15) also includes a main memory (106), such as a random access memory (RAM) or other dynamic storage device, coupled to the bus (102) for storing information and program instructions to be executed by the processor (104). The main memory (106) also may be used for storing temporary variables or other intermediate information during execution or instructions to be executed by the processor (104).

The computer system (15) further includes a read only memory (ROM) (108) or other static storage device coupled to the bus (102) for storing static information and instructions for the processor (104). a storage device (110), such as a magnetic disk or optical disk, is provided and coupled to the bus (102) for storing information and instructions. The bus (102) may contain, for example, thirty-two address lines for addressing video memory or main memory (106). The bus (102) can also include, for example, a 32-bit data bus for transferring data between and among the components, such as the CPU 104, the main memory 106, video memory and the storage media (110). Alternatively, multiplex data/address lines may be used instead of separate data and address lines.

In one embodiment, the CPU (104) comprises a microprocessor manufactured by Motorola®, such as the 680X0 processor or a microprocessor manufactured by Intel®, such as the 80X86, or Pentium® processor, or a SPARC® microprocessor from Sun Microsystems®. However, any other suitable microprocessor or microcomputer may be utilized. The main memory (106) can comprise dynamic random access memory (DRAM). And video memory (not shown) can comprise a dual-ported video random access memory.

The computer system (15) may be coupled via the bus (102) to a display (112), such as a cathode ray tube (CRT), for displaying information to a computer user. An input device (114), including alphanumeric and other keys, is coupled to the bus (102) for communicating information and command selections to the processor (104). Another type of user input device comprises cursor control (116), such as a mousse, a trackball, or cursor direction keys for communicating direction information and command selections to the processor 104 and for controlling cursor movement on the display (112). This input device typically has two degrees of freedom in two axes, a first axis (e.g., x) and a second axis (e.g., y) that allows the device to specify positions in a plane.

According to one embodiment of the invention, the steps of the processes encoded in the hardware and software modules of the present invention is provided by computer systems (15) in response to the processor (104) executing one or more sequences of one or more instructions contained in the main memory (106). Such instructions may be read into the main memory (106) from another computer-readable medium, such as the storage device (110). Execution of the sequences of instructions contained in the main memory (106) causes the processor (104) to perform the process steps described herein. One or more processors in a multi-processing arrangement may also be employed to execute the sequences of instructions contained in the main memory (106). In alternative embodiments, hard-wired circuitry such as Application Specific Integrated Circuit (ASIC) may be used in place of or in combination with software instructions provided by software modules to implement the invention. Thus, embodiments of the invention are not limited to any specific combination of hardware circuitry and software modules.

The term “computer-readable medium” as used herein refers to any medium that participated in providing instructions to the processor 104 for execution. Such a medium may take may forms, including but not limited to, non-volatile media, volatile media, and transmission media. Non-volatile media includes, for example, optical or magnetic disks, such as the storage device (110). Volatile media includes dynamic memory, such as the main memory (106). Transmission media includes coaxial cables, copper wire and fiber optics, including the wires that comprise the bus (102). Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions, which encoded in various software modules, to the processor (104) for execution. For example, the instructions may initially be carried on a magnetic disk of a remote computer. The remote computer can load the instructions into its dynamic memory and send the instructions over a telephone line using a modem. A modem local to the computer system (15) can receive the data on the telephone line and use an infrared transmitter to convert the data to an infrared signal. An infrared detector coupled to the bus (102) can receive the data carried in the infrared signal and place the data on the bus (102). The bus (102) carries the data to the main memory (106), from which the processor (104) retrieves and executes the instructions. The instructions received from the main memory (106) may optionally be stored on the storage device (110) either before or after execution by the processor (104).

The computer system (15) also includes a communication interface (118) coupled to bus the (102). The communication interface (118) provides a two-way data communication coupling to a network link (120) of the net1 or net2 (11) that is connected to routers in net1 or net2 (11). For example, the communication interface (118) may be an integrated services digital network (ISDN) card or a modern to provide a data communication connection to a corresponding type of telephone line, which can comprise part of the network link (120). As another example, the communication interface (118) may be a local area network (LAN) card to provide a data communication connection to a compatible LAN. Wireless links may also be implemented. In any such implementation, the communication interface (118) sends and receives electrical electromagnetic or optical signals that carry digital data streams representing various types of information.

The network link (120) typically provides data communication through one or more networks to other data devices. For example, the network link (120) may provide a connection through a local network to a host/server computer or to data equipment operated by an Internet Service Provider (ISP) (126) via switched of net1 or net2 (11). The ISP (126) in turn provides data communication services through the world wide packet data communication network now commonly referred to as the “Internet” (128). The Internet (128) uses electrical electromagnetic or optical signals that carry digital data streams. The computer system (15) further includes web server (7) for providing e.g. a user interface to the clients (10) for requesting data streams from the virtual server (16). In one example said user interface can include a list of available video content files in the virtual video server (16) and ways of selecting content files for viewing, including optionally payment terms.

The computer system (15) can send messages and receive data, including program code, through the communication interface (118). In the Internet example, clients (10) can transmit code (e.g., program instructions, HTML, etc.) for an application program through the Internet (128), the ISP (126), and communication interface (118).

The example versions of the invention described herein can be implemented as logical operations in a distribution control station (2). The logical operations of the present invention can be implemented as a sequence of steps executing on distribution control station (2). The implementation is a matter of choice and can depend on performance of the distribution control station (2) implementing the invention. As such, the logical operations constituting said example versions of the invention are referred to for e.g. as operations, steps or modules.

The present invention has been described in considerable details with references to prior applications from the same inventor and preference to certain preferred versions, examples, and figures; however, other versions, and samples are also possible. Therefore, the spirit and scope of the appended claims should not be limited to the description of the preferred versions and samples contained herein.

What is claimed is:

1. (canceled)

2. A method of set user secure access control for a virtual server, in which
the virtual server includes a plurality of system units, and
a control system controlling the system units automatically forming one or multiple service pools across a network infrastructure, and maintaining the resource information of the virtual server including information of the service pools, and providing web user interfaces (“UI”) for displaying the resource information of the virtual server into user's web browser including display said information as web based multi-layered item lists (“MLIL”);
the method implemented in the control system includes the steps of
a) facilitating the privileged user from a web UI including via web MLIL to select a resource information of the virtual server to submit a task of set access control for permitting a designated user to access the selected information;
b) receiving and parsing the task of set access control transmitted from the web browser;
c) executing the task by storing the information of the selected resource and a system on which the resource is resided into the designated user's security profile;
d) repeating above acts beginning at the step a) for assigning said designated user and one or more designated users with permission of accessing one or more resources on one or more systems of the virtual server.

3. A control system of a virtual server providing secure accessing and managing resources of the virtual server includes:
at least a CPU and memory;
a control manager for communicating to the service agent of each system unit to automatically form one or multiple service pools across a network infrastructure, and storing and maintaining resources information of the virtual server including the information of the service pools;
a web service control for transmitting and displaying information of the virtual server into user's web browser via web user interfaces (“UI”) including displaying resources as web based multi-layered item lists (“MLIL”); and
a security control for controlling user from where to access and access what resources of the virtual server and perform what task; wherein
the control system facilitates privileged user via web UI performing tasks of set user secure access control for a plurality of designated users, and
permits said designated users via web UI secure accessing the virtual server only based on permissions specified in the designated user's security profile.

4. The control system of claim 3, wherein said performing tasks of set user secure access control further includes
a method implemented in the control system for set user secure access control including the steps of
a) facilitating the privileged user from a web UI to select a resource information of the virtual server to submit a task of set access control for permitting a designated user to access the selected information;
b) receiving and parsing the task of set access control transmitted from the web browser;
c) executing the task by storing the information of the selected resource and a system on which the resource is resided into the designated user's security profile;
d) repeating above acts beginning at the step a) for assigning said designated user and one or more designated users with permission of accessing one or more resources on one or more systems of the virtual server.

5. The control system of claim 3, wherein said performing tasks of set user secure access control further includes:
selecting a service pool of the virtual server for assigning it to a designated user for permitting the user accessing the entire selected service pool including each system unit in the service pool and each system unit's hardware and data resources.

6. The control system of claim 3, wherein said performing tasks of set user secure access control further includes:
selecting a system unit in a service pool of the virtual server for assigning it to a designated user for permitting the user accessing the entire selected system unit including its hardware and data resources.

7. The control system of claim 3, wherein said performing tasks of set user secure access control further includes:
selecting the control system of the virtual server for assigning it to a designated user for permitting the user accessing the entire control system including its hardware and data resources.

8. The method of claim 3, wherein said performing tasks of set user secure access control further includes:
assigning a selected hardware device on a system of the virtual server to a designated user for permitting the user accessing and managing the selected hardware device including storage and network device on the selected system.

9. The control system of claim 3, wherein said performing tasks of set user secure access control further includes:
selecting a list of storage devices on s system of the virtual server for assigning it to a designated user for permitting the user managing each storage device on the selected list.

10. The control system of claim 3, wherein said performing tasks of set user secure access control further includes:
selecting a file system on a system of the virtual server for assigning it to a designated user for permitting the user accessing and managing the entire file system includes its hierarchical file-folder structure and files.

11. The control system of claim 3, wherein said performing tasks of set user secure access control further includes:
selecting a data file on a system of the virtual server for assigning it to a designated user for permitting the user accessing the selected data file including document, digital picture, video, audio, image file.

12. The control system of claim 3, wherein said performing tasks of set user secure access control further includes:
selecting a application program file on a system of the virtual server for assigning it to a designated user for permitting the user accessing the selected application service.

13. The control system of claim 3, wherein said performing tasks of set user secure access control further includes:
selecting a folder on a system of the virtual server for assigning it to a designated user for permitting the user accessing the selected folder and the resources including data and application program files resided under the folder.

14. The control system of claims 10-13 further includes:
assigning one or more designated users to accessing a same selected data resource of the virtual server.

15. The control system of claim 3, wherein said security control further includes:
specifying security attributes into each user's security profile for permitting the user only from a web browser on the user's specific native system to access the virtual server.

16. The control system of claim 3, wherein said security control further includes:
creating user security profile and specifying user's role, credentials and permissions into the user's security profile for permitting the user accessing one or more resources of the virtual server and performing specific tasks for the virtual server.

17. The control system of claim 3, wherein said security control further includes:
maintaining each user's secure accessing record file to be linked to the user's security profile for tracking information of the user's every interacting to the virtual server, and each record in said file including the user's name, accessed from where and at what time, accessed what resources and performed what tasks on what systems of the virtual server.

18. The control system of claim 3, wherein said security control further includes:
updating user security profile in response to changing status of the user's role and security credential.

19. The control system of claim 3, wherein said security control further includes:
deleting user security profile in response to changing status of the user's role and security credential.

20. The control system of claim 3, wherein said security control further includes:
validating and permitting each user's accessing the resources of the virtual server only based on permissions specified in the user's security profile.

21. The control system of claim 3, wherein said permitting designated users via web UI secure accessing the virtual server further includes:
facilitating user accessing the entire virtual server via a web MLIL, which includes top level of one or multiple service pool nodes, each service pool's next level of one or multiple system units, and each system unit's next multiple levels of hardware and data resources.

22. The control system of claim 3, wherein said permitting designated users via web UI secure accessing the virtual server further includes:
permitting user accessing and managing the resources of the virtual server via web MLIL on which same type of resource nodes linked with same type of operation menu and different type of resource nodes linked with different type of operation menu, wherein said accessing and managing include performing said task of set user secure access control.

23. A web based virtual server provides secure accessing and managing its resources including:
at least a console system being configured with web browser;
a plurality of system units and each one being configured with a service agent for providing service including web service,
at least a control system that includes CPU and memory, and interconnects to each system unit and console system; wherein
the control system also includes
a control manager for communicating to the service agent of each system unit to automatically form one or multiple service pools across a network infrastructure, and maintaining resources information of the virtual server including the information of the service pools;
a security control for controlling user secure accessing the virtual server including permitting each user from where to access, access what resources and perform what task; and
a web service control coupled with the security control for transmitting and displaying information of the virtual server into user's web browser via web user interfaces (“UI”) including displaying resources as web based multi-layered item lists (“MLIL”) and
facilitating privileged user via web UI performing tasks of set user secure access control for a plurality of designated users, and
permitting said designated users via web UI secure accessing the virtual server only based on permissions specified in the designated user's security profile; and
a web multi-tasks control for controlling each user's a web browser submitted multiple tasks being capable of running concurrently in the web browser without blocking the web browser screen.
